(19) United States
(12) Patent Application Publication
(10) Pub. No.: US 2006/0200789 A1
(43) Pub. Date: Sep. 7, 2006

(54) Connectivity verification of IC (integrated circuit) mask layout database versus IC schematic; LVS check, (LVS: IC layout versus IC schematic) via the internet method and computer software

(76) Inventor: Dan Rittman, Durham, NC (US)

Correspondence Address: DANNY RITTMAN, 5101 STARCROSS LANE, DURHAM, NC, 27713, US

(21) Appl. No.: 11/071,020

(22) Filed: Mar. 3, 2005

(51) Int. Cl. G06F 17/50

(52) U.S. Cl. 716/19; 716/4

(57) ABSTRACT

This paper describes an EDA (Electronic Data Automation) method and computer software invention for connectivity verification of IC mask Layout database versus IC Schematic; LVS Check (LVS: IC Layout versus IC Schematic) over the internet. The technique takes advantage of a unique algorithm to check the mask layout database connectivity, compare it with its corresponding schematic diagram for any mismatches in the mask layout polygons connections. The input of the tool is a mask layout database blocks (i.e.: IC layout) that were made manually and/or automatically using synthesized tools. These blocks may have some connectivity mismatches that need to be fixed in order to match the corresponding integrated circuit (IC) schematic diagrams. The output of the software tool is a text based descriptive log file and errors markers pointers that may be read into the mask layout database in order to point any connectivity mismatches of the mask layout database, comparing it to its corresponding schematic diagram. The end result is a mask layout set of markers and a text format log file that describes any mismatched connections in the mask layout database, comparing it to its corresponded schematic diagram. The software performs on individual mask layout blocks and/or on hierarchical structure of mask layout blocks. The system works hierarchically and/or flat. System also checks mask layout database incrementally, means only blocks that have been changed are checked. The system can be run via the internet using our secured protocol. The system offer a web based control panel to execute all necessary setups for submitting LVS check over the internet. The system offers the option to run on a local machine (user's computer) or on the main server over the internet. (Inventor's computer) The system also offers a PDA (Personal Digital Assistant) interface to launch LVS runs via industry's standard PDA's. The procedure is fully secured by 128 bit security protocol. All necessary file including mask layout GDSII (or GDSIII) file, netlist and technology file are securely encrypted using 128 bit protocol and send to the remote server. These files are decrypted and submitted for LVS check on the remote servers. The main remote server is distributing the task among other computer system for advanced parallel processing to achieve fast results. All results log files are encrypted using 128 bit security protocol and available for download by the user. In case of local LVS check the results files are available on the user's local machine.

### BACKGROUND OF THE INVENTION

This invention relates generally to the design of integrated circuits. As is well known, a large number of integrated circuit chips are manufactured on a single semiconductor wafer by a number of sequential steps. One or more process steps are involved in altering or forming a circuit layer. Several layers are sequentially built one on top of the other. The shape of the operation performed on each layer is defined by an optical mask.

Typically, a first process step is to diffuse or implant ions into the semiconductor wafer substrate in a pattern defined by a diffusion mask. A second step is then typically to form polysilicon gates in a pattern of another mask. A next step may be to form contacts with the polysilicon and substrate diffusion regions, and that is done by yet another mask. A next step is to connect the contacted gates and diffusions regions with metal conductors, so another mask is provided for defining conductor interconnections.

Although what has been described is typical, minimum process, many IC's required many more steps and thus several more layout masks for use in implementing those steps. Further, in certain cases, the sequence of the masking steps as described above may be different, and/or certain of the steps of this simple case may require two or more masks to implement.

In initially designing such an IC, a schematic diagram of the electronic circuit is first prepared. Such a diagram shows the interconnections of all of the electronic elements that are desired to be implemented on an integrated circuit chip. Once the schematic diagram is completed, it is tested with the use of available computer software tools. After it has been determined from these tests that an electronic circuit in accordance with the schematic diagram will operate as desired, this schematic is then converted into a mask design database that defines polygons on each set of masks. These masks are then optically fabricated for use in the manufacturing process (i.e.: mask layout).

Typically, a mask layout block is created manually by a mask designer or an automated synthesizes software tool. (For example: Place and Route software tool). The output results in both ways are layout blocks that may have LVS (Layout Vs Schematics) mismatches. An LVS mismatch means a mask layout connection that does not match the corresponding schematic data file (netlist) electrical connection. A mistaken mask layout polygon connection between nets that does not match the equivalent connection according to the schematic data file, may lead to a failure of the circuit. During the conversion from circuit's diagram to the layout database, the mask designer or the synthesized automated tool creates some mistaken interconnections between related polygons. When the entire layout block construction is done, it is tested for connectivity match using computer software tool (LVS—Layout versus Schematics). After interconnects mismatches have been determined, then the block will have to go through a process of manual ‘cleaning’ of those mismatches. A ‘cleaning’ of such mismatches means moving related mask layout polygons to create a match connection according to the schematic data file (netlist). Avoiding doing so will create wrong interconnections between mask layout nodes on the actual wafer that will lead to the electronic circuit failure.

The main advantage of the method and computer software that described in this invention is that users can submit LVS check via a web based control panel. The LVS check can be submitted using a web based control panel via any secured internet browser. This LVS check can be executed on the inventor's remote sever or the user's local computer. The advantage of submitting LVS check on the inventor's server is based on the fact that this server is fast super computer system and will run in a very short time. The system is based on web based control panel. User can setup LVS check using control panel's setup controls like check-boxes, buttons and pull-down menus. The communication with the main remote server is secured by 128 bit security protocol. All information remains fully confidential on the remote server. The main remote server is distributing LVS check among other computer system for parallel processing, achieving faster results. In case that the user choose to submit LVS check on his own local machine, the program offers an option to distribute the task on the user's local computer system for parallel processing to achieve faster results. When LVS check is complete, the user will be notified via the control panel and an optional email message about the check completion. All results log files are available on he remote server or the user local server by the user's choice. The user is able to download all results files including violations marker file(s) to be loaded on mask layout database editor for visual viewing purposes.

Therefore, it is a primary object of the present invention to provide a technique and computer software that detects all connectivity mismatches of a mask layout block according to the schematic data file (netlist) in a very short time, to be run over the internet. The system will verify all mask layout interconnection/s by comparing them to the corresponding schematic data file (netlist). This process is also called: LVS (Layout Versus Schematics). System checks individual IC layout blocks and/or hierarchical mask layout structure. System also has the capability to work incrementally. Working incrementally means after first time mask layout database has been checked, from that stage and on, only the mask layout blocks that have been changed, will be re-checked. This method saves a significant amount of time during IC layout design verification. This method enables integrated circuit design corporations to annually license web based LVS check and therefore do not need to purchase a complete LVS checker software which is very expensive. This method and system significantly reduce the cost of integrated circuits LVS check and make it affordable for small and medium size integrated circuits design corporations. This fact enables corporations to become more profitable and successful on the long run.

### SUMMARY OF THE INVENTION

This and additional objects are accomplished by the present invention, Wherein, briefly, connectivity mismatches in mask layout database/s are detected by comparing the mask layout database polygon's connectivity to it's corresponding schematic data file (netlist) and executed over the internet.

Each layout block of the IC is tested for interconnectivity mismatches comparing to its corresponded schematic data file (netlist). As a connectivity mismatch is being detected, a note is written into a text-based logfile and an error marker is been created. This error marker can be loaded into the mask layout database in order to point the location of the error.

The layout block has to be read in a specific format GDSII stream. This format is the most common in the VLSI industry for IC layout database representation. The software processes the layout block/s and the output result is an error marker file and a text based logfile. The text-based logfile is a descriptive way to explain the connectivity mismatch between the mask layout database and the schematic diagram. Analyzing the logfile provides the solutions for correcting the connectivity mismatch.

The computer software also detects connectivity's mismatches in hierarchical layout structure. A hierarchical IC layout structure is a ‘parent-child’ mask layout blocks structure. The most significant reason for using this method is to avoid repetitive drawing of the same circuit. Instead of constructing the same circuit again, we create it once as a ‘sub cell’ and then use it in a verity of places within other cells. The computer software checks the entire mask layout hierarchy for connectivity mismatches and provides logfile results and error markers file. The system also has the capability to perform an incremental check. An incremental check means that after first time IC mask layout database check, only blocks that have been changed will be checked again. This is a major time saving factor since the computer software does not need to run the entire mask layout database each time that only few blocks have been changed.

The technique and the computer program of the present invention make it very easy to check mask layout block/s for interconnectivity mismatches. These are necessary stages during chip design process. Generally, a mask designer would spend a significant amount of time (depends on the layout block size) on fixing interconnectivity mismatches. With this present invention, a single software command is all that is necessary to check the mask layout block/s for connectivity mismatches.

The system offers a web based control panel to submit complete LVS checks over the internet. The user has the option to submit the LVS check locally (on his own computer system) or on a powerful remote server. In case of local run, the system checks with the remote server about the existence of a license and when it gets the approval, the LVS (Layout vs Schematic) check will be submitted locally on the user's computer system. If the user chooses to submit LVS check on the remote server, few setups are required. These setups include the submission of the schematic netlist file, the mask layout DGSII file and the technology file. All these files are encrypted and securely transmitted using 128 bit security protocol to the remote server. On the remote server all received information is decrypted and the LVS check is executed. The remote server is distributing all LVS checks on other computer systems for parallel processing to achieve faster results. In case of a local LVS check on the user's local computer, the system offers the option to distribute the LVS execution task among user's local computer systems for parallel processing to achieve faster results. After LVS check completion all necessary results log files and marker files are available for download directly from the remote server or to be load locally, in case of a local execution. This approach eliminates the purchase of a full local license and enables affordable price for small and medium size chip design firms. Also by offering advanced servers, corporations may save the cost of purchasing high end computer systems for verification purposes. Offering advanced servers to submit LVS checks enable fast run time for very large databases. This fact significantly reduces integrated circuits design cost and time to market factor for chip design corporations, enabling faster deliveries to their customers.

Additional objects, advantages and features of the present invention will become apparent from the following description of its preferred embodiments, which description should be taken in conjunction of the accompanying drawings.

### BRIEF DESCRIPTION OF THE DRAWINGS

FIG. 1 schematically illustrates the system basic operation. The system includes remote internet computer system and main server that serves multi-user LVS (IC layout vs schematic) checks that are submitted over the internet.

### DESCRIPTION OF A PREFERRED EMBODIMENT

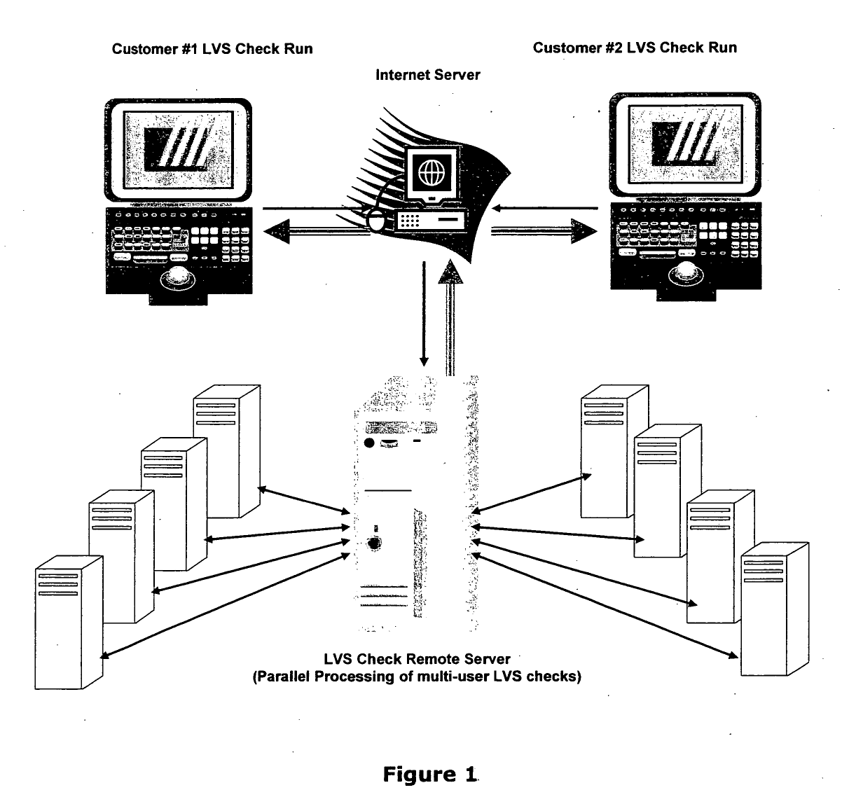

Referring to FIG. 1, conceptually illustrates is the schematic diagram of a VOI system. (Verification over Internet)

The system consists of two (2) major components. Component #1 is the internet server and component #2 is the LVS (layout vs schematic) check server. The internet server is a powerful computer to route all LVS requests according to priority and queue to the LVS check server. The LVS check remote server is a powerful super computer that distributes all LVS checks information for parallel processing execution on other computer systems at the main inventor's location. The main computer program is running on the LVS check remote server and can handle multi-user, multi-technology LVS checks execution. All technology files and LVS check setups are encrypted before sent to the main LVS server. This information then is decrypted at the main LVS check server and executed. A separate computer program that is synchronized with the LVS check program is running on the internet server to manage LVS checks requests traffic, priority and queue. When each LVS check is complete all results are automatically available on the main LVS check remote server. The LVS check remote server informs the internet server about the LVS check completion, which inform the user about the run completion and the availability of the result files.

It is important to mention that the computer software is working on GDSII and GDSIII Stream format database (industry standard IC layout representation) which covers all the commercial layout editors in the VLSI field today. The system supports with CDL and HSpice format for IC schematics.

1. A method for checking the connectivity of an integrated circuit (IC) mask layout database by interpreting instance and connection nodes parameters from a schematic data file (netlist) representing the circuit design schematic over the internet, wherein the circuit design schematic includes one or more instances and connection nodes defined at different levels of hierarchy. The mask layout database is representing the circuit design schematic and indudes all instances and connection nodes defined at different levels of hierarchy, said method comprising:
comparing the mask layout database to the corresponding schematic data file (netlist) including the steps of traversing the hierarchy of the schematic to locate each of the instances in the mask layout; and,
checking each instance and connection node in the mask layout database to determine if the instance or connection node is connected according to its corresponding schematic data file;
evaluating the parameter for each mask layout instance; and,
in case of mismatched between the mask layout database and the schematic data file (netlist), note the mismatch in a text format log file and create an error marker that can be read into the mask layout database in order to show the error location.

2. The method according to claim 1, wherein said one instance is a sub-circuit of the circuit design schematic, and wherein said one mask layout database changes the connectivity of said sub-circuit instance.

3. The method according to claim 1, wherein said one instance consists of a one electronic component.

4. The method according to claim 1, wherein the netlist file that is created is a hierarchical netlist file.

5. The method according to claim 1, wherein the netlist file that is created is a flat netlist file.

6. A system for connectivity checking of a mask layout database, over the internet by interpreting instance parameters from a schematic data file representing the circuit design schematic, wherein the circuit design schematic includes one or more instances defined at different levels of hierarchy;
an input mechanism for reading a schematic data file parameters and mask layout database parameters in GDSII (or GDSIII) format to compare the interconnectivity to the corresponding schematic data file (netlist); and,
a traversal engine for creating the netlist file from the schematic data file, said traversal engine traversing the schematic to locate the instances of electronic components and to compare the interconnectivity of the schematic data and the mask layout database nets.

7. The method of claim 1, where the circuit design schematic and the corresponding mask layout database have multiple levels in a hierarchy.

8. The method of claim 1, where checking the interconnectivity of the sets of the mask layout nets includes merging predetermined ones of the nets together.

9. The system of claim 6, where the circuit design schematic has multiple levels, and where the engine traverses the levels hierarchically.

10. The system of claim 6, where the engine locates the instance of the schematic data file (netlist) and the value of the parameters at different levels of the schematic data file.

11. The system of claim 6, where the system has the capability to work incrementally, means check only the mask layout blocks that have been changed.

12. A computer program product comprising:
a computer usable medium having a computer readable program code means embodied therein for checking the connectivity of a mask layout database by interpreting instance parameters from a schematic data file representing the circuit design schematic, wherein the circuit design schematic includes one or more instances defined at different levels of hierarchy; the computer readable program means in said computer program product comprising:
computer readable program code means for causing a computer to read a circuit design schematic parameters data file (netlist) for each instance;
computer readable program code means for causing a computer to read a mask layout database in GDSII format parameters for each instance;
computer readable program code means for causing a computer to traverse the hierarchy of the schematic to locate each of the instances in sequence;
computer readable program code means for causing a computer to traverse the hierarchy of the mask layout database to locate each of the instances in sequence;
computer readable program code means for causing a computer to check each instance located in the mask layout database to determine if the instance is electrically connect as in the corresponding schematic data file (netlist);
computer readable program code that creates a graphic GUI (Graphic User Interface) that offer a user the option to dick on the mismatched errors in order to load the error in the mask layout editor interactively.
computer readable program code means for causing a computer to verify the interconnectivity of the mask layout database against the corresponded schematic diagram information (netlist) for any mismatched connection/s between the schematic data file (netlist) and the mask layout database.

14. The computer program product according to claim 6, wherein the netlist file that is created is a flat netlist file.

15. The computer program product according to claim 6, wherein the netlist file that is created is a hierarchical netlist file.

16. The method according to claim 1, wherein computer software is used for establishing real time communications, with a main computer server to run LVS check over the internet, comprising:
(a) a built-in software program capable of automatically connecting to the internet and providing a means for data transferring for the purpose of real time LVS check, and,
(b) a external software program capable of being downloaded from a network or internet work computer allowing internet users to connect to a common network or internet work providing a means for data transfer for the purpose of real time LVS check, and,
(c) an external software program capable of providing parallel processing on many remote servers providing a means of real time LVS check.

17. The method according to claim 1, wherein said LVS run is done via the internet running on the customers local machine or on the inventor's remote server by submitting through a secured web browser.

18. The method according to claim 1, wherein said LVS run can be launched via standard PDA (Personal Digital Assistant)

19. The method according to claim 1, wherein said that LVS check, over the internet, can work on flat and hierarchical netlist.

20. The method according to claim 6, wherein said that LVS check is done over the internet on the inventors remote server or on the user's local computer comprising:
(a) Web based control panel to setup all technology file, constraints and additional necessary setups for LVS check, and, p1 (b) 128 bit based security protocol to securely encrypt and transfer all user's confidential information to the inventor's remote server for LVS check processing including mask layout GDSII file, netlist file and technology file, and,
(c) All LVS run log file results will be available on the inventor's remote server or the users local computer system, and,
(d) LVS run can be submit in two (2) modes, flat or Hierarchical including flat or hierarchical report generation, and,
(e) The system produces LVS results markers file to be bad on mask layout database program, for LVS violations identification, and,
(f) All result files in text mode can be read using standard PDA (Personal Digital Assistant) device.

21. The method according to claim 1, wherein said that the main remote server is distributing LVS checks among other computer systems for parallel processing purpose to achieve faster results.

22. The method according to claim 1, wherein said in case of user's local LVS check execution the system offers an option to distribute the LVS check among other local computer systems for parallel processing purpose to achieve faster results.
